(19) United States
(12) Patent Application Publication
(10) Pub. No.: US 2009/0280957 A1
(43) Pub. Date: Nov. 12, 2009

(54) HYDRAULIC CONTROL DEVICE OF AUTOMATIC TRANSMISSION

(75) Inventors: Tetsuya Shimizu, Anjo - shi (JP); Kenichi Tsuchida, Anjo - shi (JP); Masamichi Yamaguchi, Anjo - shi (JP); Satoshi Nishio, Hekinan - shi (JP); Akitomo Suzuki, Anjo - shi (JP); Kazunori Ishikama, Anjo - shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN AW CO., LTD, Anjo-shi (JP)

(21) Appl. No.: 12/252,916

(22) Filed: Oct. 16, 2008

(30) Foreign Application Priority Data
Oct. 19, 2007 (JP) 2007-272335

(51) Int. Cl. F16H 61/06

(52) U.S. Cl. 477/115

(57) ABSTRACT

A hydraulic control device of an automatic transmission having a pick up unit of a feedback oil passage that is provided in a line pressure oil passage branched from an oil passage communicating an oil pressure source and a pressure regulating port with each other. An influence of an oil pump on a feedback pressure is thus reduced, and a primary regulator valve regulates an oil pressure to a stable line pressure having a small amount of rising. This structure prevents instability of the feedback pressure due to the influence of the oil pump which is caused in the case where a feedback pressure of a primary regulator valve is directly obtained from an oil passage communicating from an oil pressure source to a pressure regulating port.

### INCORPORATION BY REFERENCE

The disclosure of Japanese Patent Application No. 2007-272335 filed on Oct. 19, 2007 including the specification, drawings and abstract is incorporated herein by reference in its entirety.

### BACKGROUND OF THE INVENTION

1. Field of the Invention

The present invention relates to a hydraulic control device of an automatic transmission that is mounted on an automobile. More particularly, the present invention relates to a structure of a feedback pressure supplying portion of a primary regulator valve for regulating an oil pressure from an oil pump to a line pressure.

2. Description of the Related Art

In general, in a primary regulator valve, a spool is biased to one direction by a spring, and a throttle pressure from a linear throttle valve also acts on one end of the throttle. A feedback pressure acts on the other end of the spool. An oil pressure from an oil pump is thus regulated to a line pressure (for example, see Japanese Patent Application Publication No. JP-A-2007-177934).

Although it is not clear from the figures of a hydraulic circuit, the feedback pressure is obtained directly from an oil passage connecting a supply port (oil pressure source) of a valve body for receiving an oil pressure from the oil pump and a pressure regulating port of the primary regulator valve to each other, and the feedback pressure thus obtained is guided to a feedback pressure chamber at the other end of the spool. The oil pressure from the oil pressure source thus directly acts on the primary regulator valve as the feedback pressure.

A line pressure oil passage communicating with a line pressure port of a manual valve is branched from the oil passage communicating the oil pressure source and the pressure regulating port with each other.

This structure can be schematically shown by a hydraulic circuit of FIG. 3 or 4. More specifically, a primary regulator valve 1 has a spool 2. A spring 3 and a throttle pressure P_{SLT} from a throttle port 4 act on one end of the spool 2, and a feedback pressure P_{FB} from a feedback port 5a acts on the other end of the spool 2. A pressure regulating port 10 communicates with an oil passage 9 for receiving a discharge pressure of an oil pump 7. A drain port 11 and a secondary port 12 are provided adjacent to the pressure regulating port.

In the primary regulator valve 1, the spool 2 moves based on the throttle pressure P_{SLT} from a throttle valve formed by a solenoid valve or the like and the feedback pressure P_{FB}, and the pressure regulating port 10 communicates with the drain port 11 and the secondary port 12 with its oil pressure at a predetermined rate, whereby the oil pressure of the pressure regulating port 10 is regulated to a predetermined line pressure.

A feedback oil passage 5 communicating with the feedback port 5a is extended directly from the oil passage 9 communicating a supply port (oil pressure source) A for supplying an oil pressure from the oil pump 7 to a valve body and the pressure regulating port 10 with each other, and extends to the feedback port 5a. A line pressure oil passage 13 is branched (branched portion C) from the oil passage 9. The oil passage 13 communicates with a line pressure port 13a of a manual valve 14. A line pressure P_{L} in the oil pressure 13 is supplied through a D range port 13b of the manual valve 14, or directly through an oil passage 13c, to a shift control unit 15 formed by a multiplicity of linear solenoid valves.

In the hydraulic circuit of FIG. 3, the feedback oil passage 5 is extended from a portion B close to the oil pressure source A of the oil passage 9 (on the oil pressure source A side of the branched portion C of the line pressure oil passage). In the hydraulic circuit of FIG. 4, the feedback oil passage 5 is extended from a branched portion D located on the pressure regulating port 10 side of the branched portion C of the line pressure oil passage in the oil passage 9.

In the hydraulic circuit of FIG. 3, a feedback pressure P_{FB} is obtained from a portion B located closer to the oil pressure source A than the branched portion C of the line pressure oil passage 13 in the oil passage 9 is, and is supplied to the feedback port 5a of the primary regulator valve 1. Therefore, the feedback pressure P_{FB} is affected by the discharge pressure of the oil pump 7 and the line pressure P_{L} at the pressure regulating port 10 of the primary regulator valve 1 is likely to vary and is likely to be set to a higher (rising) value.

In the hydraulic circuit of FIG. 4, a feedback pressure P_{FB} is obtained directly from the oil passage 9 communicating from the oil pressure source of the oil pump 7 to the pressure regulating port 10. A line pressure P_{L} around the pressure regulating port 10 is therefore regulated to a predetermined oil pressure. However, the further the distance from the pressure regulating port 10 is (the closer the distance to the oil pump is), the more the line pressure P_{L} is likely to be affected by the discharge pressure of the oil pump and is likely to be set to a higher value.

This degrades control accuracy of the shift control unit 15 receiving the line pressure P_{L} and may adversely affect the valves of the shift control unit. Especially, hydraulic control devices having a shift control unit 15 including a multiplicity of linear solenoid valves for regulating an oil pressure by directly receiving a line pressure have appeared in recent years. In such hydraulic control devices, if the varying line pressure P_{L} having a rising value acts on the linear solenoid valves, plunger vibration may occur especially in the case of normally open type linear solenoid valves, which facilitates abrasion.

### SUMMARY OF THE INVENTION

It is therefore an aspect of the present invention to provide a hydraulic control device of an automatic transmission that addresses the above problem by obtaining an oil pressure from a branched line pressure oil passage as a feedback pressure of a primary regulator valve.

According to a non-limiting embodiment of the present invention, a hydraulic control device of an automatic transmission for regulating an oil pressure from an oil pressure source to a line pressure in a primary regulator valve and supplying the line pressure to a shift control unit is characterized in that the primary regulator valve includes a feedback port for applying a feedback pressure that biases a spool to one direction, a throttle port for applying a throttle pressure that biases the spool to another direction, and a pressure regulating port for regulating the oil pressure to the line pressure, and a line pressure oil passage is branched from an oil passage communicating the oil pressure source and the pressure regulating port with each other and guides the line pressure toward the shift control unit, and a pick up unit of a feedback oil passage for supplying the feedback pressure toward the feedback port is provided in the line pressure oil passage.

The feedback pressure of the primary regulator valve is obtained from the line pressure oil passage that is branched from the oil passage communicating the oil pressure source and the pressure regulating port with each other. The feedback pressure is therefore a stable oil pressure having a reduced influence of an oil pump, and the primary regulator valve can regulate an oil pressure to a stable line pressure having a small amount of rising.

Referring to, for example, FIG. 2, the hydraulic control device of the automatic transmission includes a valve body having a first valve body and a second valve body integrally fixed to each other with a separator plate interposed therebetween. The first valve body is provided with the oil pressure source, the oil passage communicating the oil pressure source and the pressure regulating port with each other, and the line pressure oil passage. The second valve body is provided with the feedback oil passage, and the pick up unit is a through hole formed in the separator plate so as to communicate the line pressure oil passage and the feedback oil passage with each other.

With the above structure, the feedback oil passage, extended from the line pressure oil passage, can be easily formed in the valve body without interfering with the oil passage communicating the oil pressure source and the pressure regulating port with each other, the spool, and the like.

The present invention can be applied to the hydraulic control device of the automatic transmission in which the shift control unit includes a multiplicity of linear solenoid valves each having an input port to which the line pressure is directly supplied, and at least one of the multiplicity of linear solenoid valves is a normally open type linear solenoid valve.

Since a stable line pressure having a small amount of rising is supplied to the input ports, the linear solenoid valves of the shift control unit can be accurately controlled. Especially, even when the linear solenoid valves are normally open type linear solenoid valves, plunger vibration is suppressed and damage to the linear solenoid valves is reduced. Reliability of the hydraulic control device of the automatic transmission can thus be improved.

### BRIEF DESCRIPTION OF THE DRAWINGS

FIG. 1 is a diagram showing a hydraulic circuit according to the present invention;

FIG. 2A is a side view showing an overall structure of a valve body to which the present invention is applied;

FIG. 2B is a plan view of a front valve body showing the valve body to which the present invention is applied;

FIG. 2C is a plan view of a middle valve body showing the valve body to which the present invention is applied;

FIG. 3 is a diagram showing a hydraulic circuit of related art; and

FIG. 4 is a diagram showing a hydraulic circuit of related art.

### DETAILED DESCRIPTION OF EXEMPLARY EMBODIMENTS OF THE INVENTION

Hereinafter, a non-limiting embodiment of the present invention will be described with reference to the accompanying drawings.

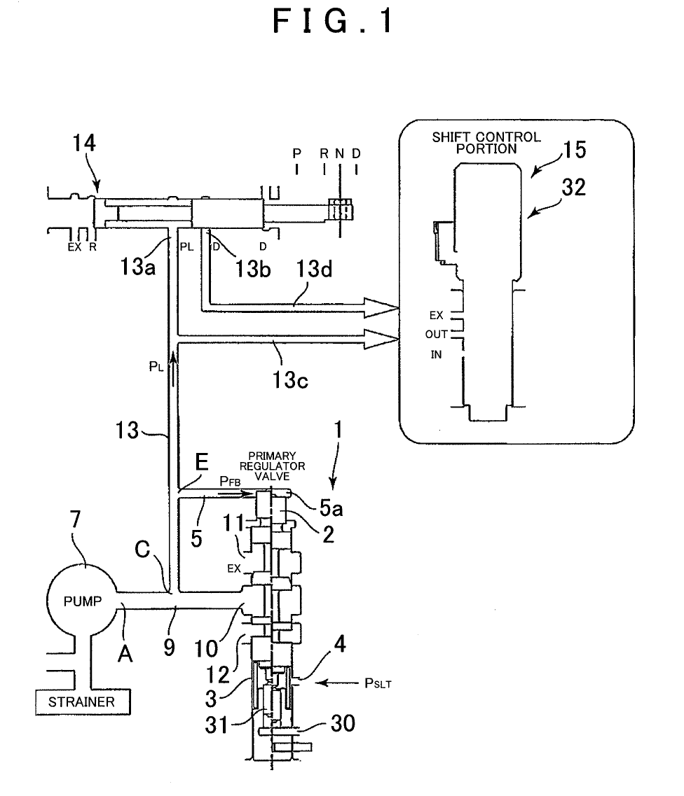

FIG. 1 is a diagram of a hydraulic circuit schematically showing a structure of a valve body. In a primary regulator valve 1, a pressure regulating port 10, a drain port 11 communicating with an intake side of an oil pump 7, a secondary port 12 communicating with a secondary regulator valve, a throttle port 4 for receiving a throttle valve P_{SLT} from a throttle valve formed by a linear solenoid valve or the like, an R range port 30 for receiving an R range line pressure, and a feedback port 5a are formed in a valve body. The primary regulator valve 1 has a spool 2. The spool 2 is biased to one direction by a spring 3.

In the primary regulator valve 1, the spring 3 and the throttle pressure P_{SLT} from the throttle port 4 thus act on one end of the spool 2 so as to bias the spool 2 to one direction {upward), and a feedback pressure P_{FB} from the feedback port 5a acts on the other end of the spool so as to bias the spool in the other direction (downward). When these are balanced, the pressure regulating port 10 communicates with the drain port 11 and the secondary port 12 at a predetermined rate, whereby a line pressure P_{L} is regulated. Note that when a manual valve 14 is in a reverse (R) range, the R range pressure from the R range port 30 acts on one end of the spool 2 through a plug 31.

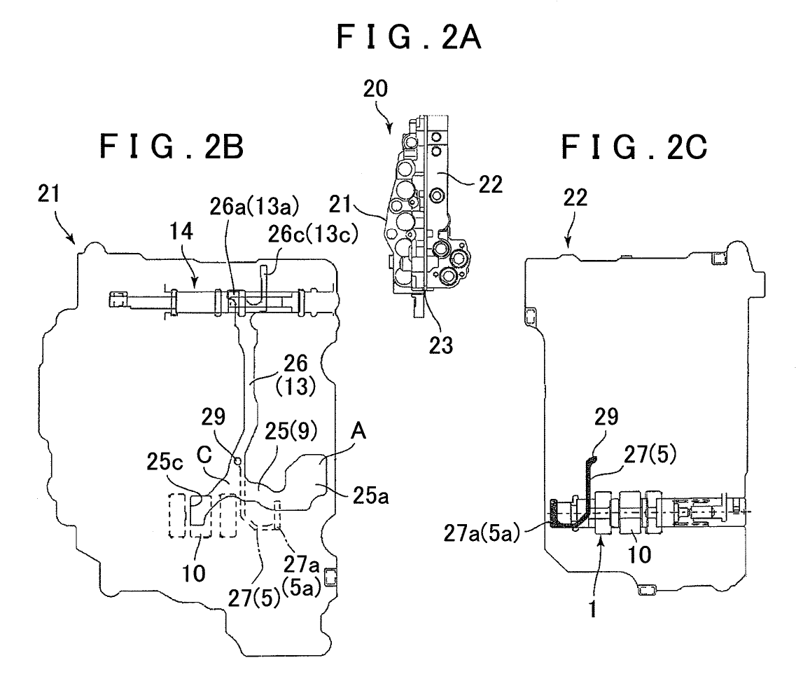

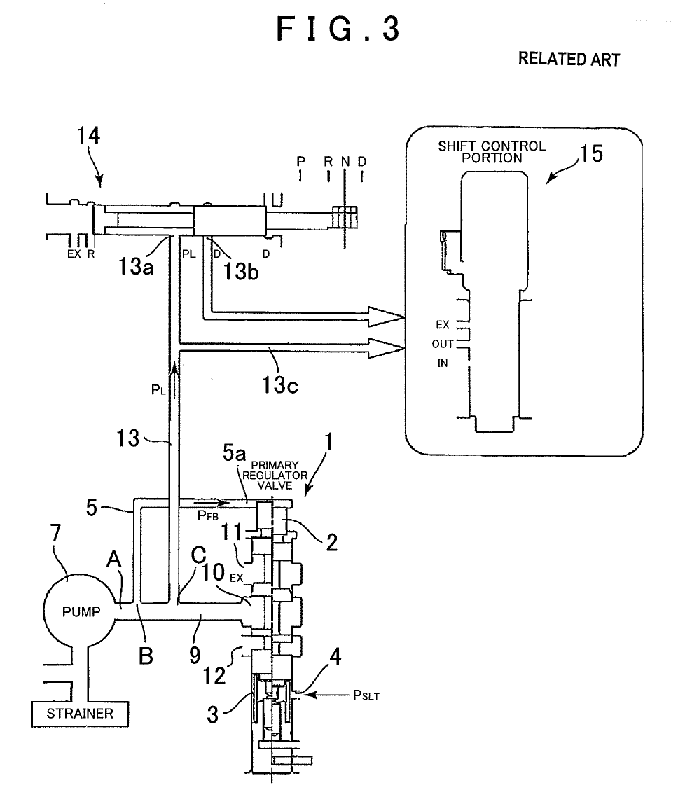

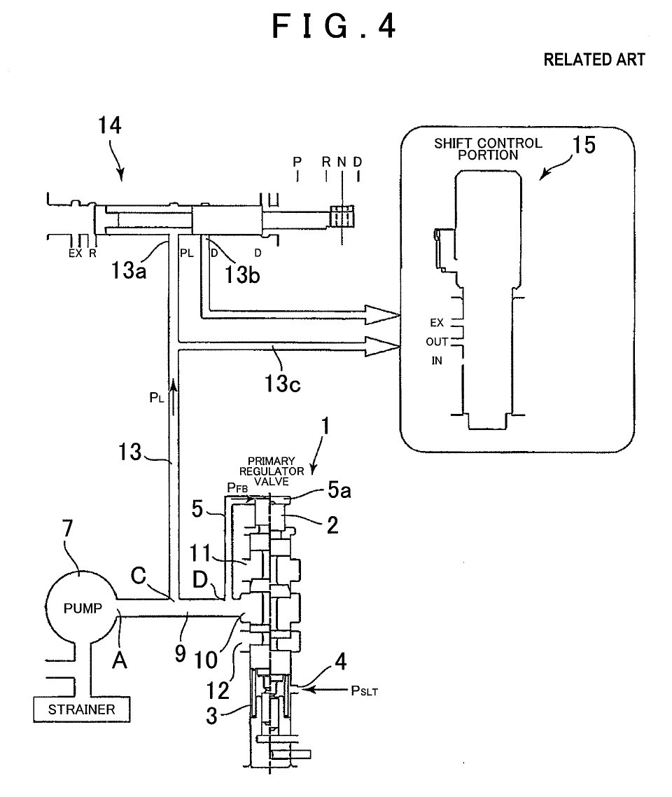

An oil passage 9 extends so as to communicate from a supply port (oil pressure source) A of the oil pump 7 to the pressure regulating port 10. A line pressure oil passage 13 is branched from the oil passage 9 (branched portion C). The line pressure oil passage 13 communicates with a line pressure port 13a of the manual valve 14 and a direct line pressure oil passage 13c. Moreover, a feedback oil passage 5 is branched (E) from the line pressure oil passage 13 (corresponding to a separator plate through hole 29 in FIG. 2 described below). The feedback oil passage 5 communicates with the feedback port 5a.

The shift control unit 15 includes a multiplicity of linear solenoid valves 32. The line pressure P_{L} is supplied through the direct line pressure oil passage 13c to an input port of at least one of the linear solenoid valves, and the line pressure P_{L} is supplied from a D range port 13b of the manual valve 14 to an input port of the remainder of the linear solenoid valves through an oil passage 13d. At least one of the linear solenoid valves 32 is a normally open type linear solenoid valve.

FIG. 2 shows non-limiting diagrams specifically showing a valve body to which the present invention is applied. As shown in FIG. 2A, a valve body 20 has a front valve body 21 (a first valve body) and a middle valve body 22 (a second valve body). These valve bodies 21, 22 are integrally fixed to each other with a separator plate 23 interposed therebetween.

As shown in FIG. 2B, the manual valve 14 is mounted in an upper part of the front valve body 21, and a through portion 25a serving as an oil pressure source A for receiving an oil pressure from the oil pump is formed in the front valve body 21. A groove 25 that forms the oil passage 9 is formed from the oil pressure source portion 25a. The groove 25 extends to an empty portion 25c serving as the pressure regulating port 10 of the primary regulator valve 1, and is branched (branched portion C) to form a groove 26 serving as the line pressure oil passage 13. An empty portion 26a serving as the line pressure port 13a of the manual valve 14 is formed at the other end of the groove 26. The groove 26 further extends to form a groove 26c serving as the direct line pressure oil passage 13c.

As shown in FIG. 2C, the primary regulator valve 1 is mounted in a lower part of the middle valve body 22. A shallow groove 27 that forms the feedback oil passage 5 is formed at a surface of the middle valve body 22. One end of the shallow groove 27 communicates with an empty portion 27a that forms the feedback port 5a of the primary regulator valve 1. The other end of the shallow groove 27 communicates with a through hole 29 (a pick up unit) formed in the separator plate 23. In the front valve body 21, the through hole 29 communicates with the groove 26 that forms the line pressure oil passage 13 branched at the branched portion C.

Note that in the primary regulator valve 1 portion of the middle valve body 22, the shallow groove 27 that forms the feedback oil passage 5 extends across the spool 2 in a portion close to the feedback port 5a which is a small diameter portion of the spool 2. The shallow groove 27 thus communicates with the empty portion 27a that forms the feedback port. In this way, the shallow groove 27 can be extended from the groove 26 that is the line pressure oil passage 13 branched (C) from the oil passage 9, without interfering with the oil passage 9 formed by the groove 25 in the front valve body 21 and without interfering with the spool 2.

Since the present non-limiting embodiment is structured as such, an oil pressure (the through hole 29 in the separator plate 23, a branched portion E) obtained from the line pressure oil passage 13 (groove 26) is guided to the feedback port 5a of the primary regulator valve 1 as a feedback pressure P_{FB}. The line pressure oil passage 13 (groove 26) is branched at C from the oil passage 9 (groove 25) communicating the oil pressure source A and the pressure regulating port 10 with each other. The feedback pressure P_{FB} obtained from the line pressure oil passage 13 is therefore a stable oil pressure without pulsation and rising, which is not directly affected by the discharge pressure of the oil pump 7.

In the primary regulator valve 1, the feedback pressure P_{FB} that is a stable oil pressure described above acts on one end of the spool 2, and the accurately controlled throttle pressure P_{SLT} from the throttle port 4 acts on the other end of the spool 2, whereby an oil pressure at the pressure regulating port 10 is appropriately regulated as a line pressure. The appropriate line pressure P_{L} at the pressure regulating port 10 further stabilizes the feedback pressure P_{FB} obtained from the line pressure oil passage 13 branched from the oil passage 9. The primary regulator valve 1 thus regulates an oil pressure to a stable line pressure without rising based on the above excellent circulation.

The line pressure P_{L} is supplied to the input port of each linear solenoid valve 32 of the shift control unit 15 through the line pressure port 13a, the D range port 13b, and the oil passage 13d of the manual valve 14 or through the direct line pressure oil passage 13c. Accordingly, each linear solenoid valve 32, especially each normally open type linear solenoid valve, accurately controls the oil pressure for a long period of time and supplies a predetermined regulated oil pressure to each hydraulic servo without being damaged by rising of the line pressure of the input port.

The hydraulic control device according to the present invention is used in an automatic transmission that is mounted in an automobile. Specifically, the hydraulic control device according to the present invention is a hydraulic control device having a multiplicity of linear solenoid valves having an input port to which a line pressure is directly supplied.

The above description of the exemplary embodiments of the invention have been given by way of example. From the disclosure given, those skilled in the art will not only understand the present invention and its attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. A hydraulic control device of an automatic transmission for regulating an oil pressure from an oil pressure source to a line pressure in a primary regulator valve and supplying the line pressure to a shift control unit, wherein
the primary regulator valve comprising:
a feedback port that applies a feedback pressure that biases a spool to one direction,
a throttle port that applies a throttle pressure that biases the spool to another direction, and
a pressure regulating port that regulates the oil pressure to the line pressure, and
a line pressure oil passage is branched from an oil passage communicating the oil pressure source and the pressure regulating port with each other, the line pressure oil passage guiding the line pressure toward the shift control unit, and
a pick up unit of a feedback oil passage that supplies the feedback pressure toward the feedback port from the line pressure oil passage.

2. The hydraulic control device of the automatic transmission according to claim 1, further comprising a valve body having a first valve body and a second valve body integrally fixed to each other with a separator plate interposed therebetween,
wherein
the first valve body is provided with the oil pressure source, the oil passage communicating the oil pressure source and the pressure regulating port with each other, and the line pressure oil passage,
the second valve body is provided with the feedback oil passage, and
the pick up unit is a through hole formed in the separator plate that communicates the line pressure oil passage and the feedback oil passage with each other.

3. The hydraulic control device of the automatic transmission according to claim 1, wherein
the shift control unit includes a multiplicity of linear solenoid valves each having an input port to which the line pressure is directly supplied, and at least one of the multiplicity of linear solenoid valves is a normally open type linear solenoid valve.

4. The hydraulic control device of the automatic transmission according to claim 2, wherein the shift control unit includes a multiplicity of linear solenoid valves each having an input port to which the line pressure is directly supplied, and at least one of the multiplicity of linear solenoid valves is a normally open type linear solenoid valve.

5. The hydraulic control device of the automatic transmission according to claim 2, further comprising a manual valve mounted in an upper part of the first valve body.

6. The hydraulic control device of the automatic transmission according to claim 2, wherein the primary regulator valve is mounted in a lower part of the second valve body.
